(19) United States
(12) Patent Application Publication
(10) Pub. No.: US 2003/0026970 A1
(43) Pub. Date: Feb. 6, 2003

(54) Method of manufacturing a soft trim assembly and resultant article

(75) Inventors: Cynthia L. Hernandez, Canton, MI (US); Diane C. Jones, Hungtington Wood, MI (US)

Correspondence Address: John C. Cooper III, FOLEY & LARDNER, 777 East Wisconsin Avenue, Milwaukee, WI, 53202-5367, US

(73) Assignee: Johnson Controls Technology Company

(21) Appl. No.: 09/918,944

(22) Filed: Jul. 31, 2001

(51) Int. Cl. B32B 5/14

(52) U.S. Cl. 428/297.4

(57) ABSTRACT

A method for manufacturing a soft trim component includes placing a cover for the soft trim assembly in a mold, filling the cover with a polymeric filler, heating the filler material and the cover to a temperature to partially melt at least one of the filler or cover and compressing the cover and the polymeric filler to bond the cover and filler into a soft trim assembly of desired shape. The cover preferably includes an inner layer having a melting or softening point which enhances the bond, the preferred cover being a double knit having an inner polymeric layer having a lower melting point than an outer layer. PET is the preferred material for constructing at least the inner layer of the cover.

### FIELD OF THE INVENTION

The present invention relates to a method for manufacturing a soft trim assembly, for example, for use in vehicle trim applications, and the resulting article. More particularly, the invention relates to an interior soft trim component which is easy to manufacture and which is readily recyclable.

### BACKGROUND OF THE INVENTION

Interior trim, such as seating surfaces, instrument panels, door panels, arm rests, headrests, consoles and compartment doors are located throughout vehicles. These trim panels must be appealing to the customer and maintain a high degree of durability. Additionally, because automotive trim makes up a large part of a vehicle's interior, the trim must be lightweight so as not to unduly weigh down the vehicle with the resulting sacrifice in fuel efficiency.

Typical automotive seating is constructed of several layers of material including an outer decorative layer, inner foam comfort layers, and rigid support layers which are mounted to various mechanism assemblies or to the body of the vehicle. In other areas of vehicle interiors, many different methods and materials have been used to construct the outer trim. In conventional configurations, the outer decorative layer is made of a fabric or synthetic resin polymer, often textured to simulate the look and feel of leather, and the outer layer may have a cellular padding or cushion layer therebeneath. Polyurethanes have been frequently used for seat cushion, trim components, etc. The support layer is frequently metal, natural fiber materials, rigid plastics and various combinations and subcombinations or these materials.

While conventional vehicle trim products, such as those described above, are suitable for their particular end uses, manufacturing them requires several materials to be joined together in order to achieve a finished product. Thus, the trim assemblies tend to be relatively expensive to manufacture. For example, leather requires lamination prior to assembly. Also, it is sometimes difficult to join an outer decorative layer and a foam inner layer made from dissimilar materials, so either adhesives or fasteners must be used to impart the desired durability.

While it is desirable to provide thermal comfort in such trim assemblies, certain current products do not breathe. For example, leather is not porous, and adhesive layers may prevent air flow, even if some of the materials would normally permit air flow.

Because trim assemblies have been made of varying materials, including adhesives and fasteners, it is also difficult to effectively recycle the materials without adding to the labor costs for separating the various materials. Recycling of vehicle parts is becoming increasingly important, not only because some materials are readily reusable, but because several jurisdictions have passed laws mandating that a certain percentage of post-consumer content be recyclable. Thus there is a need for manufacturing vehicle trim assemblies, and the resultant products, which can be made in an inexpensive manner and which retain the desired aesthetic, durability and weight characteristics and at the same time eliminate unnecessary materials and thereby improve the ability to recycle such components.

It is known in the art of making trim components to use molds heated by the flow of hot air to bond polymer fibers to various cover materials. Two patents owned by the assignee of this invention are Kargol et al., U.S. Pat. Nos. 5,494,627 and 5,492,662. In the latter, the mold is constructed to heat the polymer fiber at different densities to create a different feel for the passenger in different areas of a seat. In the former, a coating is bonded to the polymer fiber pad, with an intermediate porous layer and the mold is closed and opened twice to allow the various fibers to bond, separate and rebond with the fibers for enhanced durability and comfort.

### FEATURES AND SUMMARY OF THE INVENTION

A primary feature of the present invention is to provide a method for manufacturing a soft trim assembly comprising a cover and a filler.

Another feature of the present invention is to provide a method for attaching a cover to a filler to give a resultant product having desirable aesthetic and feel characteristics, and bonding of the filler in a convenient and rapid manner.

A different feature of the present invention is to provide a method for joining PET fibers to one side of a trim cover which itself consists of two layers of thermoplastic yarn or synthetic fabric, an inner layer which has a lower melting point with respect to the material used for the outer layer.

Another feature of the present invention is to promote thermal comfort using breathable materials.

A still further feature of the present invention is to provide a plurality of layers of fabric which are integrally processed together to serve as the cover for a soft trim assembly, which fabric is porous so that heated air may be used in a mold to join it to a polymer filler.

Yet another feature of the present invention is to provide a method for manufacturing a soft trim assembly and a resulting article which is made entirely from a single type of polymeric fabric/yarn, such as PET.

How these and further features of the invention are accomplished individually, collectively, or in various subcombinations will become apparent to those skilled in the art after they have read the following description taken in conjunction with the drawings. Generally, however, the features of the invention are accomplished in the most preferred embodiment by providing a layer of a double-knit material having an outer layer of relatively high melt synthetic fabric/yarn when compared to the fibers used to prepare the inner layer. The knit is placed in a mold having numerous air inlets so that the higher melt layer is in contact with the mold surface. The individual precut PET polymer fibers are blown into the mold in contact with the low melt side of the knit, and the mold is closed and heated to bond the fibers to the low melt side of the jersey. Other ways in which the features of the invention are accomplished will become apparent to those skilled in the art after they have read the specification, and such other ways are also contemplated to be within the scope of this invention if they fall within the scope of the claims which follow.

### DETAILED DESCRIPTION OF THE DRAWINGS

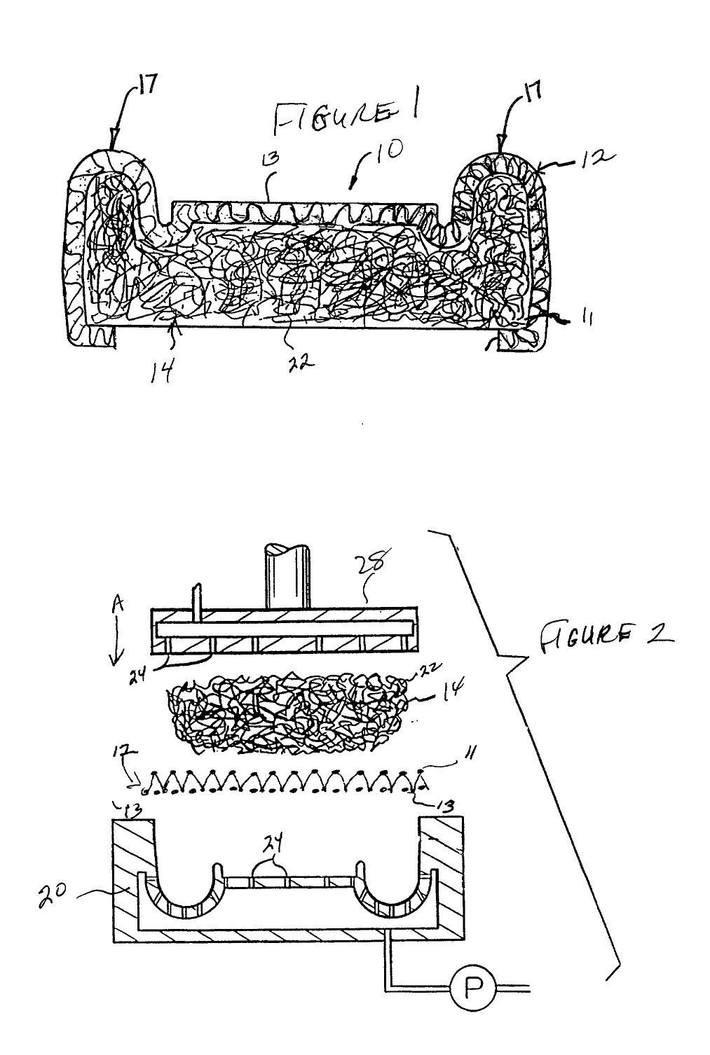

FIG. 1 is a sectional view showing a soft trim assembly produced by the present invention; and

FIG. 2 is an exploded view showing the process used to make the article of FIG. 1.

### DETAILED DESCRIPTION OF THE PREFERRED EMBODIMENT

Before beginning the detailed description of the preferred embodiment, several general comments can be made about the applicability and the scope of the present invention. First, a cover comprising two layers of synthetic fabric/yarn is used in the illustrated embodiments and is preferred. To construct this double knit material, a higher melt yarn is knit to a lower melt yarn using a knitting machine, such as that shown in Shibata et al., U.S. Pat. No. 6,199,409. While the knit is preferred, other materials may be substituted therefor which have first and second layers, the inner one of which (when referring to the final article) is thermoplastic and has a lower melting or softening temperature than the outer layer. These may include other porous materials than the knit identified above, or fabrics made from additional materials and including a thermoplastic polymer layer which may either be in fiber, foam or layer form. Preferably, the material should be air permeable and stretchable.

Second, while the illustrations show schematically the use of the process and article of the present invention in connection with vehicle seating, other vehicle trim panels can be made using this process.

Third, the mold shown in the schematic illustrations uses forced air heat to soften the inner layer of the cover fabric and/or the loose polymer fibers of the filler, but other types of molds may be employed, such as those which use other techniques for heating the mold contents. The choice of the particular mold heating system will depend on such factors as molding speed, the thickness of the ultimate article to be produced, and the like.

Fourth, while PET fibers are preferred for the filler to be attached to the cover, other thermoplastic resin materials may be used. These include mixtures of fibers of different melting temperature, different fiber diameter and especially coated fibers which have a central core having a first higher melting point and a surrounding sheath having a second lower melting point. What is important is that at least one of the inner layer of the cover fabric and the filler be adequately softened through a heating process to bond them together in a fast and uniform manner.

Fifth, while recyclability of the seating components is highly desirable, the invention is not to be limited to recyclable articles.

Sixth, foams can be used in lieu of fibers, although fibers are preferred. As indicated above, the fibers can have different melting temperatures so that a portion of the fibers which have a low melting temperature and a portion having a high melting temperature are intermixed. Specifically, for PET, the low melting fibers can have a melting point around 150° F. (65.6° C.), whereas the high melting fibers can have melting points around 300° F. (148.9° C.) or above. In the preferred embodiment, the polymer fibers have an inner core of the high melting temperature material and an outer sheath or covering that melts at the low temperature.

Proceeding now to a description of the FIGURES, FIG. 1 illustrates in sectional view of a soft trim article 10 made according to the preferred embodiment. Trim assembly 10 includes a double knit cover material 12 which itself includes an outer layer 13, an inner layer 11, as is the case with the double knit material described above. Filler material 14 comprise a randomly dispersed mixture of fibers, preferably made from PET, which have been molded to conform to the shape of the mold (not shown) and to bond to inner layer 11. Also, it is noted in FIG. 1 that two raised contours 17 are provided, representing seat portions, such as bolsters.

A schematic illustration of the starting materials for making article 10 is shown in FIG. 2 where the lower mold is depicted at 20. The cover material 12 is again shown to include an outer layer 13 which will contact the inner surface of the mold 20 and an inner layer 11 that contacts the filler material 14. In this illustration, the filler is less compacted than in FIG. 1 and comprises a plurality of chopped/loose fibers 22 which may be selected from those described above. FIG. 2 also indicates that lower mold 20 and upper mold 28 includes a plurality of openings 24 which are used in the preferred embodiment to admit hot air through the mold wall and through the permeable cover material 12 into the filler pad 14. Such molds, in and of themselves, are known, and are shown in, for example, the two Kargol et al. patents identified above.

The process itself comprises closing mold element 28 in direction A, against the fibers 22 to urge them against the inner layer 11 to cause the individual fibers 22 to bond to each other and to layer 11. The length of time which the mold needs to be heated, and the pressure used in the mold, can be widely varied by those skilled in the art after they have read this specification. In and of themselves, the heated mold technology is not part of the present invention, but rather the invention is more related to the particular materials used for the exterior trim cover and the filler.

While the present invention has been described in connection with a specific preferred embodiment, the invention is not to be limited to such description, but is to be limited solely by the scope of the claims which follow.

What is claimed is:

1. A method for manufacturing a soft trim assembly comprising:
placing a cover for a soft trim assembly into a mold, the cover having inner and outer polymer fiber knit layers, the outer layer being in contact with the mold and the fibers of the outer layer having a higher melting temperature than the fibers of the inner layer;
placing of a predetermined amount of a thermoplastic polymeric filler in the mold in contact with the inner layer of the cover;
heating the polymeric filler and cover to a temperature sufficient to partially melt at least one of the polymeric filler or the inner layer of the cover; and
compressing the cover and the polymeric filler to bond the polymeric filler and cover to form a soft trim assembly of a desired shape.

2. The method of claim 1 wherein the polymeric filler consists of polymeric fiber.

3. The method of claim 1 wherein the polymeric filler is polyethylene terephthalate (PET).

4. The method of claim 1 wherein the two cover layers are processed into a stretchable, double layer knit fabric.

5. The method of claim 1 wherein the polymeric cover and the polymeric filler each contain a PET polymer.

6. The method of claim 5 wherein the filler is PET fibers.

7. The method of claim 1 wherein the heating step is conducted using heated air.

8. A method for manufacturing a soft trim assembly consisting essentially of polymeric components comprising:
placing a cover for a soft trim assembly into a mold, the cover comprising a two layer knit fabric made from thermoplastic polymeric fibers, the fabric having an outer layer which contacts the mold and an inner layer, the inner layer having a lower melting point than the outer layer;
filling the polymeric cover with a predetermined amount of a thermoplastic polymeric filler, at least a portion of the polymeric filler having a melting point less than that of the outer layer of the cover;
heating the polymeric filler and the cover to a temperature sufficient to partially melt at least one of the polymeric filler and the cover to bond the two together; and
compressing the polymeric filler and cover into a soft trim assembly of a desired shape.

9. The method of claim 8 wherein the polymeric filler is a pad of PET fibers.

10. The method of claim 8 wherein the inner layer of the cover is a PET fiber knit.

11. A soft trim panel comprising:
a double knit cover having an outer layer, an inner thermoplastic polymer layer, the outer layer and inner layer being constructed together, the panel also including a filler made from a thermoplastic polymer, the pad and inner cover layers being bonded to each other by melted thermoplastic polymer.

12. The trim panel of claim 11 wherein both layers of the cover are PET and the filler is PET.

13. The trim panel of claim 11 wherein the outer layer of the cover has a higher melting point than the inner layer thereof.

14. The trim panel of claim 11 wherein the filler comprises PET fibers.

15. The trim panel of claim 14 wherein the filler fibers comprise a PET core and a surrounding sheath of PET having a lower melting point than the core.
